(19) United States
(12) Patent Application Publication
(10) Pub. No.: US 2015/0322265 A1
(43) Pub. Date: Nov. 12, 2015

(54) XANTHENE-BASED PURPLE DYE COMPOUND, COLORING RESIN COMPOSITION FOR COLOR FILTER CONTAINING SAME AND COLOR FILTER USING SAME

(71) Applicant: KYUNG-IN SYNTHETIC CO., LTD., Incheon (KR)

(72) Inventors: Soonhyun PARK, Gyeonggi-do (KR); Jeong Gi KIM, Gyeonggi-do (KR); Jung Rok KIM, Seoul (KR); Do Kyung LEE, Incheon (KR); Heon PARK, Gyeonggi-do (KR)

(21) Appl. No.: 14/388,843

(22) PCT Filed: Feb. 27, 2013
(86) PCT No.: PCT/KR2013/001565

§ 371 Date: Sep. 29, 2014

(30) Foreign Application Priority Data
Mar. 30, 2012 (KR) 10-2012-0033469

(51) Int. Cl. C09B 11/24; G02B 5/20; C08L 33/14

(52) U.S. Cl. CPC C09B 11/24; C08L 33/14; G02B 5/20

(57) ABSTRACT

The present disclosure relates to a purple dye compound for a color filter and a coloring resin composition for a color filter containing the same. The novel xanthene-based purple dye compound or the polymer dye compound obtained using the same as a monomer has superior solvent resistance and superior miscibility with a pigment in an organic solvent. Further, it exhibits superior heat resistance, chemical resistance, light resistance and brightness due to the homopolymer structure. Accordingly, a coloring resin composition containing the same can be used widely as a dye for synthetic resins and synthetic fibers, as a coloring agent for polymer materials, for a color filter used in LCDs, PDPs, etc., and so forth.

### TECHNICAL FIELD

The present disclosure relates to a purple dye compound for a color filter and a coloring resin composition for a color filter containing the same. More particularly, it relates to a novel xanthene-based purple dye compound exhibiting improved solubility in organic solvents as well as superior heat resistance, light resistance and chemical resistance or a polymer thereof, a coloring resin composition for a color filter containing the same and a color filter using the same,

### BACKGROUND ART

A liquid crystal display displays images using optical and electrical properties of a liquid crystal material. The liquid crystal display is advantageous over CRTs, plasma display panels, etc, in that it is lightweight, consumes less power and operates at lower voltage. The liquid crystal, display includes a liquid crystal layer disposed between glass substrates. Light produced by a tight source passes through the liquid crystal layer and the liquid crystal layer controls light transmittance. After passing through the liquid crystal layer, the light passes through a color filter layer. A full-color display is realized through additive color mixing of the light that has passed through the color filter layer.

In general, a color filter used for a liquid crystal display is prepared fey staining, printing, electrodeposition or pigment dispersion. Although methods of using a dye have been considered from the past, use of a dye is disadvantageous as compared to a pigment in terms of heat resistance, light resistance, chemical resistance, etc. and is also disadvantageous economically because of a complicated process. Thus, pigment dispersion is Usually employed at present. Although a pigment is less transparent than a dye, the problem has been solved through advancement in techniques for pulverising and dispersing pigments. A color filter prepared by the pigment dispersion method is stable against light, heat, solvent, etc., and it is easy to prepare a color filter for a large-screen, high-precision color display through patterning by photolithography. For this reason, the method is the most widely employed at present.

Red, green and blue pigments are used to form a RGB color filter for a pigment-dispersed color resist. In addition, yellow or violet pigments may be further included to more effectively display colors. A method of preparing a color filter by pigment dispersion is as follows. First, a color resist solution is coated on a substrate using a spin coater and a coating film is formed by drying. Then, a color pixel obtained by patterning, exposing and developing the coating film is heat-treated at high temperature to obtain a pattern of a first color. This procedure is repeated for each color. The most important factors affecting the performance of the color resist, are the characteristics, dispersibility and dispersion state of the pigment used as a coloring agent. Recently, with the trend toward large-sized, high-definition LCDs, requirements on high transmittance, high contrast ratio, narrow black matrix width, high reliability, etc. are ever increasing for a color filter. To satisfy these requirements, pigments are pulverized as much as possible to satisfy color properties such as brightness, contrast ratio, etc.

However, the pigment dispersion is problematic in that the pigment in particle state scatters fight and the rapidly increased surface area of the pigment due to Small particle size leads to formation of nonuniform pigment particles because of poor dispersion stability. As a result, it is difficult to satisfy the quality requirements of high brightness, high contrast ratio, high definition, etc. Furthermore, to prepare the pigment dispersion, synthesized pigment powder cannot be used as it is and a pigmentation process such as salt milling is necessary for stable dispersion and particle size reduction. Such a post-treatment process is not only undesirable in terms of environmental protection but also it requires many additives such as a dispersant, a pigment derivative, etc. to maintain stable dispersion as well as a very complicated and intricate process, in addition, the pigment dispersion requires complicated storage and transport conditions to maintain optimum quality.

Use of a dye instead of the pigment as a coloring agent has been studied to solve these problems and achieve high brightness, high contrast ratio and high resolution, Xanthene dyes have been investigated a lot for application to a blue color filter (Korean Patent Publication No. 2002-0002317, Korean Patent Publication No. 2006-0095475), Because the xanthene dye has a high molar absorption coefficient, it is not necessary to use the dye in large quantity. Therefore, the addition amount of other components such as a monomer, a binder or a photopolymerization initiator in a coloring resin composition is not limited. However, poor solvent resistance is a problem. Although an Ionic substance is used or a sulfonamide functional group is introduced to the dye to solve this problem, another solvent has to he used in addition to propylene glycol monomethyl ether acetate (Korean Patent Publication No. 2004-0038817, Korean Patent Publication No. 2007-0024344). In particular, because cyclohexanone used to dissolve the dye is recognized as an environmentally harmful substance, improvement of solubility in propylene glycol monomethyl ether acetate is necessary.

### DISCLOSURE

### Technical Problem

The present disclosure is directed to providing a novel xanthene-based purple dye compound exhibiting excellent solubility in an organic solvent, particularly propylene glycol monomethyl eider acetate, as well as high heat resistance, light resistance, chemical resistance and brightness, and a coloring resin composition for a color filter containing the same.

The present disclosure is also directed to providing a color filter using the coloring resin composition.

### Technical Solution

In a general aspect, the present disclosure provides a xanthene-based purple dye compound represented by [Chemical Formula 1] as a polymerizable monomer:

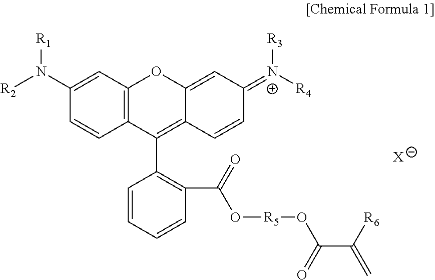

wherein

X⁻ is selected from a halogen anion, a perhalide anion, a fluorine complex anion, an alkyl sulfate anion, a sulfonate anion and a sulfonimide anion,

each of R₁, R₂, R₃ and R₄ is independently selected from hydrogen, a substituted or unsubstituted C₁-C₃₀ alkyl group, a substituted or unsubstituted C₂-C₄₈ alkenyl group and a substituted or unsubstituted C₈-C₁₀ aromatic hydrocarbon,

R₅ is a substituted or unsubstituted C₁₀ saturated hydrocarbon and

R₆ is hydrogen or a methyl group.

In another general aspect, the present disclosure provides a purple dye polymer compound obtained from a xanthene-based compound represented by [Chemical Formula 2] as a monomer;

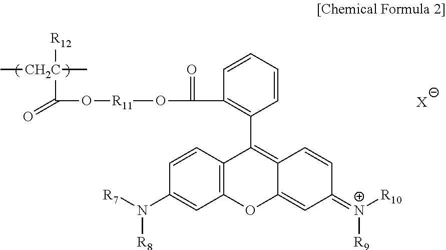

wherein

X⁻ is selected from a halogen anion, a perthalide anion, a fluorine complex anion, an alkyl sulfate anion, a sulfonate anion and a sulfonimide anion,

each of R₇, R₈, R₉ and R₁₀ is independently selected from hydrogen, a substituted or unsubstituted C₁-C₃₀ alkyl group, a substituted or unsubstituted C₂-C₄₈ alkenyl group and a substituted or unsubstituted C₈-C₁₀ aromatic hydrocarbon,

R₁₁ is a substituted or unsubstituted C₁-C₁₀ saturated hydrocarbon and

R₁₂ is hydrogen or a methyl group.

The polymer compound may have a weight-average molecular weight (M_{w}) of 2,000-150,000.

In another general aspect, the present disclosure provides a coloring resin composition for a color filter, containing; a purple dye compound; a blue pigment; a binder resin; a reactive unsaturated compound; a polymerization initiator; an organic solvent; and an additive,

wherein the purple dye compound is the purple dye compound represented by [Chemical Formula 1] or the purple dye polymer compound obtained from the compound represented by [Chemical Formula 2] as a monomer.

In an exemplary embodiment of the present disclosure, the purple dye compound may be contained in an amount of 0.01-50 wt % based on the total weight of the coloring resin composition.

In another exemplary embodiment of the present disclosure, the blue pigment may be a copper phthalocyanine-based blue pigment.

In another exemplary embodiment of the present disclosure, the weight ratio of the weight ratio of the blue pigment and the purple dye compound may be from 99:1 to 60:50.

In another exemplary embodiment of the present disclosure, the reactive unsaturated compound may be selected from a group consisting of a thermosetting monomer or oligomer, a photocurable monomer or oligomer and a combination thereof.

In another exemplary embodiment of the present disclosure, the polymerization initiator may be selected from a group consisting of a thermal polymerization initiator, a photopolymerization initiator and a combination thereof.

In another general aspect, the present disclosure provides a color filter prepared using the coloring resin composition for a color filter.

### Advantageous Effects

A dye compound according to the present disclosure or a polymer compound has superior solvent resistance and superior miscibility with a pigment in an organic solvent. Further, it exhibits superior heat resistance, chemical resistance, light resistance and brightness due to the polymer structure. Accordingly, it can be used to prepare a color filter exhibiting superior heat resistance, chemical resistance, light resistance and brightness.

### BEST MODE

Hereinafter, the present disclosure is described in further detail.

The existing xanthene dye is problematic in application to a color filter because of low solvent resistance. In the present disclosure, an anion is introduced to a xanthene dye to improve solvent resistance. The resulting dye compound is polymerizable since it contains a polymerizable functional group in the molecule and a coloring resin composition containing the same can be used to prepare a color filter exhibiting superior heat resistance, less color change and superior color characteristics.

A purple dye compound according to the present disclosure may be a xanthene-based purple dye compound represented by [Chemical Formula 1] as a polymerizable monomer.

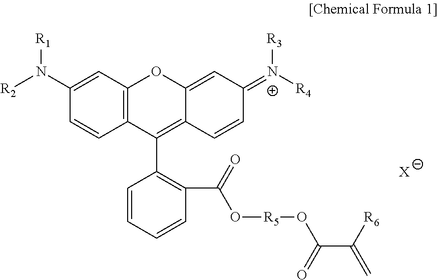

In [Chemical Formula 1], X⁻ may he selected from a halogen anion, a perhalide anion, a fluorine complex anion, an alkyl sulfate anion, a sulfonate anion and a sulfonimide anion. Specifically, it may be a trifluoromethanesulfonate or bis(trifluoromethaneJsulfonimlde anion.

Each of R₁, R₂, R₃ and R₄ may be independently selected from hydrogen, a substituted or unsubstituted C₁-C₃₀ alkyl group, specifically a substituted or unsubstituted C₁-C₁₀ alkyl group, a substituted or unsubstituted C₂-C₄₈ alkenyl group, specifically a substituted or unsubstituted C₂-C₁₀ alkenyl group and a substituted or unsubstituted C₆-C₁₀ aromatic hydrocarbon.

R₅ may be a substituted or unsubstituted C₁-C₁₀ saturated hydrocarbon and R₆ may be hydrogen or a methyl group.

Also, the purple dye compound according to the present disclosure may be a purple dye polymer compound obtained from a xanthene-based compound represented by [Chemical Formula 2] as a monomer.

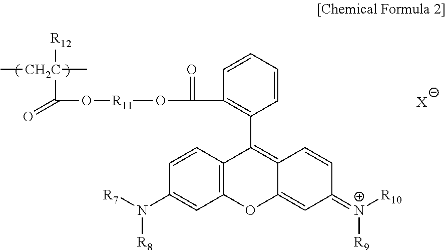

In [Chemical Formula 2], X⁻ may be selected from a halogen anion, a perhalide anion, a fluorine complex anion, an alkyl sulfate anion, a sulfonate anion and a sulfonimide anion. Specifically, if may be a trifluoromethanesulfonate or bis(trifluoromethane)sulfonimide anion.

Each of R₇, R₈, R₉ and R₁₀ may be independently selected from hydrogen, a substituted or unsubstituted C₁-C₃₀ alkyl group, specifically a substituted or unsubstituted C₁-C₁₀ alkyl group, a substituted or unsubstituted C₂-C₄₈ alkenyl group, specifically a substituted or unsubstituted C₂-C₁₀ alkenyl group and a substituted or unsubstituted C₆-C₁₀ aromatic hydrocarbon.

R₁₁ may be a substituted or unsubstituted C₁-C₁₀ saturated hydrocarbon and R₁₂ may be hydrogen or a methyl group.

The polymer compound may have a weight-average molecular weight (M_{w}) of 2,000-150,000, specifically 2,000-30,000.

A coloring resin composition for a color filter according to an exemplary embodiment of the present disclosure contains, together with the purple dye compound, a blue pigment, a binder resin, a reactive unsaturated compound, a polymerization initiator, an organic solvent and an additive.

The purple-dye compound may be the monomer compound represented by [Chemical Formula 1] or the polymer compound represented by [Chemical Formula 2] and may fee contained in an amount of 0.01-50 wt % based on the total weight of the coloring resin composition. When the purple dye compound is contained in the above-described range, the coloring resin composition may have superior solubility in a solvent as well as high brightness and superior heat resistance and light resistance.

The monomer compound represented by [Chemical Formula 1] or the polymer compound represented by [Chemical Formula 2] as the purple dye compound may be used together with one or more blue pigment. The blue pigment may be one or more blue pigment selected from ones commonly used for a coloring resin composition for a color filter. For example, a copper phthalocyanine-based blue pigment may be used. Examples of the blue pigment may include the compounds classified as pigments in Colour Index (published by the Society of Dyers and Colourists). Specific examples may include Color Index (C.I.) Pigment Blue 1, 15, 15:1, 15;2, 15:3, 15:4, 15:8, 18, 80, etc. The weight ratio of the blue pigment and the purple dye compound may be from 99:1 to 50:50.

The binder resin is not particularly limited as long as it is a resin capable of exhibiting binding properly. In particular, generally known film-forming resins may be used.

For example, a cellulose resin, particularly carboxymethyl hydroxyethyl cellulose, or hydroxyethyl cellulose, an acrylate resin, an alkyd resin, a melamine resin, an epoxy resin, a polyvinyl alcohol resin, a polyvinylpyrrolidone resin, a polyamide resin, a polyamide-imine resin, a polyimide resin, etc. may be used.

Also, the binder resin may be a resin having a photopolymerizable unsaturated bond, e.g., an acrylate resin. In particular, a homopolymer or a copolymer of a polymerizable monomer, e.g., a copolymer of a polymerizable monomer having a carboxyl group such as methyl methacrylate, ethyl methacrylate, propyl methacrylate, butyl methacrylate, styrene and styrene derivatives, methacrylic acid, itaconic acid, maleic acid, maleic anhydride and mono-alkyl maleate and a polymerizable monomer such as methacrylic acid, styrene and styrene derivatives may be useful.

Specific examples include a reaction product of a compound containing an oxirane ring and an ethylene-based unsaturated compound, e.g., glycidyl (meth)acrylate, acryloyl glycidyl ether, monoalkyl glycidyl itaconate, etc., and a carboxyl-containing polymer compound and a reaction product of a compound containing a hydroxyl group and an ethylene-based unsaturated compound (unsaturated alcohol), e.g., allyl alcohol, 2-buten-4-ol, oleyl alcohol, 2-hydroxyethyl (meth)acrylate, N-methylolacrylamide, etc, and a carboxyl-containing polymer compound. The binder may also contain an unsaturated compound without an isocyanate group.

The equivalent degree of unsaturation of the binder (the molecular weight of the binder per unsaturated compound) may be generally 200-3,000, specifically 230-1,000, to provide suitable photopolymerization properties and film hardness. The binder may have an acid value of generally 20-300, specifically 40-200, to provide sufficient alkali developing properties after exposure. The binder may have an average molecular weight of 1,500-200,000 g/mol, in particular 10,000-50,000 g/mol.

The reactive unsaturated compound may be selected from a group consisting of a thermosetting monomer or oligomer, a photocurable monomer or oligomer and a combination thereof. Specifically, it may he a photocurable monomer and may be one containing one or more reactive double bond and an additional reactive group in the molecule.

In this regard, useful photocurable monomers include, in particular, a reactive solvent or a reactive diluent, e.g., mono-, di-, tri- and poly-functional acrylate and methacrylate, vinyl ether, glycidyl ether, etc. Additional reactive groups include allyl, hydroxyl, phosphate, urethane, secondary amine, N-alkoxymethyl, etc.

These types of monomers are known in the art and are described, for example, in [Roempp, Lexikon, Lacke und Druckfarben, Dr. Ulrich Zorll, Thimem Verlag Stuttgart-New York, 1998, pp. 491-492]. Selection of the monomer depends on the type and intensity of radiation used, target reaction using a photoinitiator and film properties. The photocurable monomer may be used alone or in combination.

The polymerization initiator may be a thermosetting initiator, a photocuring initiator or a combination thereof. Specifically, it may be a photocuring initiator. The photocuring initiator is a compound that forms a reaction intermediate capable of inducing polymerization of the monomer and/or the binder by absorbing visible or UV light. The photocuring initiator is also known in the art and is described, for example, in [Roempp, Lexikon, Lacke und Druckfarben, Dr. Ulrich Zorll, Thimem Verlag Stuttgart-New York, 1998, pp. 445-446].

The organic solvent may be, for example, a ketone, alkylene glycol ether, alcohol or aromatic compound. Ketones include acetone, methyl ethyl ketone, cyclohexanone, etc., alkylene glycol ethers include methyl cellosolve (ethylene glycol monomethyl ether), butyl cellosolve (ethylene glycol monobutyl ether), methyl cellosolve acetate, ethyl cellosolve acetate, butyl cellosolve acetate, ethylene glycol monopropyl ether, ethylene glycol monohexyl ether, ethylene glycol dimethyl ether, diethylene glycol ethyl ether, propylene glycol monomethyl ether, propylene glycol monoethyl ether, propylene glycol monopropyl ether, propylene glycol monobutyl ether, propylene glycol monomethyl ether acetate, diethylene glycol methyl ether acetate, diethylene glycol ethyl ether acetate, diethylene glycol propyl ether acetate, diethylene glycol isopropyl ether acetate, diethylene glycol butyl ether acetate, diethylene glycol t-butyl ether acetate, triethylene glycol methyl ether acetate, triethylene glycol ethyl ether acetate, triethylene glycol propyl ether acetate, triethylene glycol isopropyl ether acetate, triethylene glycol, triethylene glycol butyl ether acetate, triethylene glycol t-butyl ether acetate, etc., alcohols include methyl alcohol, ethyl alcohol, isopropyl alcohol, n-butyl alcohol, 3-methyl-3-methoxybutanol, etc., and aromatic compounds include benzene, toluene, xylene, N-methyl-2-pyrrolidone, ethyl N-hydroxymethylpyrrolidone-2-acetate, etc. Examples of other solvents include 1,2-propanediol diacetate, 3-methyl-3-methyl-3methoxybutyl acetate, ethyl acetate, tetrahydrofuran, etc. These organic solvents may be used alone or in combination.

The additive is not particularly limited so long as it does not negatively affect the desired effect. Specific examples include fatty acids, fatty amines, alcohols, bean oils, waxes, rosins, resins, benzotriazole derivatives, etc. used to improve surface texture. More specifically, useful fatty acids may include stearic acid or behenie acid and useful fatty amines may include stearylamine.

### Mode For Invention

Hereinafter, the present disclosure will be described in detail through examples. However, the following examples are for illustrative purposes only and it will be apparent to those of ordinary skill in the art that the scope of the present disclosure is not limited by the examples.

Synthesis Example 1, Synthesis of compound of [Chemical Formula 3]

(1) After adding phthalic anhydride (15.7 g) and 3-(N,N-dimethylamino)phenol (15 g) to 1,2-dichlorohenzene (56.7 g) in a reactor, the resulting mixture was stirred at 175° C. for 1 hour. 1 hour later, 3-dimethylaminophenol (10 g) was added In three aliquots. After the addition was completed, the mixture was stirred at 175° C. for 12 hours. Upon completion of reaction, the mixture was cooled to below 25° C. and, after adding 3% sodium hydroxide aqueous solution (100 g), stirred for 30 minutes. After separating the organic layer and adding 4.5% sulfuric acid (330 g), the mixture was stirred for 30 minutes. After separating the aqueous layer and adding 35% hydrochloric acid (30 g) and sodium chloride (15 g), the mixture was stirred at 60° C. for 1 hour. After cooling to room temperature, the resulting crystals were filtered, washed with 2% hydrochloric acid (300 g) and dried at 80° C. to obtain a compound of [Chemical Formula A] (30 g).

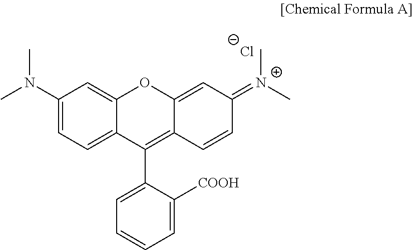

(2) After adding the compound of [Chemical Formula A] obtained in1-(1) (15.0 g) to dichloromethane (210.0 g), the mixture was stirred below 25° C. Then, thionyl chloride (12.9 g) was added dropwise below 25° C. for 30 minutes. After the addition was completed, N,N-dimethylformamide (1.3 g) was added dropwise below 25° C. for 30 minutes. After the addition was completed, reaction temperature was raised to 40° C. After stirring at the same temperature for 1 hour, the reaction mixture was cooled to below 25° C. and added to icy water (300 g). After the addition was completed, the organic layer was separated and cooled to below 0° C. Then, a mixture of 2-hydroxyethyl methacrylate and triethylamine was slowly added dropwise below 6° C. After the addition was completed, the mixture was stirred below 5° C. for 2 hours and water (200 g) and hydrochloric acid (10 g) were added. The organic layer was concentrated and dried to obtain a compound: of [Chemical Formula B] (10.0 g).

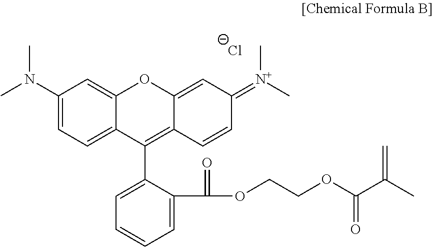 [SMILES: C=C(C)C(=O)OCCOC(=O)c1ccccc1-c1c2ccc(=[N+](C)C)cc-2oc2cc(N(C)C)ccc12 ; [Cl-]]

(3) The compound of [Chemical Formula 8] (10.0 g) obtained in 1-(2) was added to dichloromethane (100 g) and dissolved at 25° C. Lithium bis(trifluoromethane) sulfonamide (113 g) dissolved in water (200 g) was added dropwise to the solution of the compound of [Chemical Formula 8] for 30 minutes. The mixture was stirred for about 1 hour and, upon completion of reaction, the organic layer was separated, After removing the solvent through distillation, methanol (50 g) was added and the mixture was stirred for 1 hour. The resulting mixture was added dropwise to water (200 g) for about 1 hour. The precipitated crystals were filtered, washed with water (200 g) and dried at 30° C. under reduced pressure to obtain a compound of [Chemical Formula C] (9.0 g),

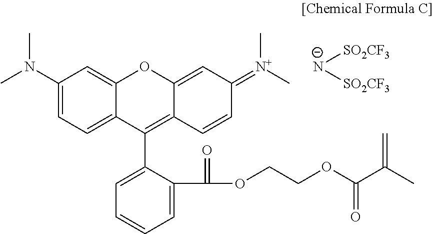

(4) Under nitrogen atmosphere, methyl ethyl ketone (22.8 g) was heated to 70° C. In a reactor, in a separate reactor, the compound of [Chemical Formula C] (98.0 g), methyl ethyl ketone (91.1 g) and 2,2′-azobisisobutyronitrile (0.3 g) were added and dissolved at 25° C. The resulting mixture was added to the previously prepared methyl ethyl ketone solution for 3 hours at 70° C. After the addition was completed, the mixture was maintained at 70° C. for 12 hours. Upon completion of reaction, after concentrating the methyl ethyl ketone to 3/2, crystallization was conducted by adding hexane (150 g). The resulting crystals were filtered and dried to obtain a compound of [Chemical Formula 3] (5.0 g).

Number-average molecular weight (Mₙ)=4250, weight-average molecular weight=6018, polydispersity (PD)=3.4.

Synthesis Example 2. Synthesis of compound of [Chemical Formula 4]

(1) After adding phthalic anhydride (15.7 g) and 3-(N,N-dimethylamino)phenol (18.0 g) to 1,2-dichlorobenzene (57.0 g) in a reactor, the resulting mixture was stirred at 175° C. for 1 hour. 1 hour later, 3-(N,N-diethylamino)phenol (12.1 g) was added in three aliquots. After the addition was completed, the mixture was stirred at 175° C. for 12 hours. Upon completion of reaction, the mixture was cooled to below 25° C. and, after adding 3% sodium hydroxide aqueous solution (100 g), stirred for 30 minutes. After separating the organic layer and adding 4.5% sulfuric acid (330 g), the mixture was stirred for 30 minutes. After separating the aqueous layer and adding 35% hydrochloric acid (30 g) and sodium chloride (15 g), the mixture was stirred at 80° C. for 1 hour. After cooling to room temperature, the resulting crystals were filtered, washed with 2%: hydrochloric acid (300 g) and dried at 80° C. to obtain a compound of [Chemical Formula D] (35 g).

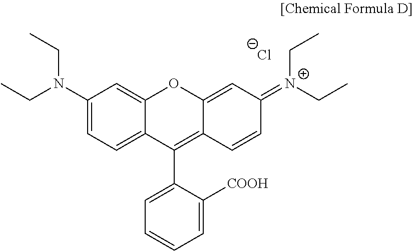 [SMILES: CCN(CC)c1ccc2c(-c3ccccc3C(=O)O)c3ccc(=[N+](CC)CC)cc-3oc2c1 ; [Cl-]]

(2) After adding the compound of [Chemical Formula D] obtained in 2-(1) (17.0 g) to dichloromethane (238.0 g), the mixture was stirred below 25° C. Then, thionyl chloride (12.9 g) was added dropwise below 25° C. for 30 minutes. After the addition was completed, N,N-dimethylformamide (1.3 g) was added dropwise below 25° C. for 30 minutes. After the addition was completed, reaction temperature was raised to 40° C. After stirring at the same temperature for 1 hour, the reaction mixture was cooled to below 25° C. and added to icy water (300 g), After the addition was completed, the organic layer was separated and cooled to below 0° C. Then, a mixture of 2-hydroxyethyl methacrylate and triethylamine was slowly added dropwise below 5° C. After the addition was completed, the mixture was stirred below 5° C. for 2 hours and water (200.0 g) and hydrochloric acid (10 g) were added. The organic layer was concentrated and dried to obtain a compound of [Chemical Formula E] (11.0 g).

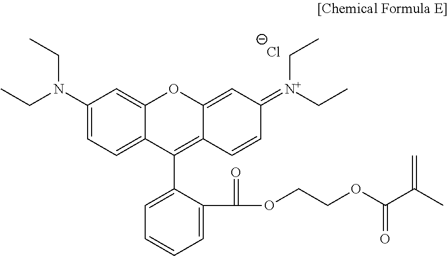 [SMILES: C=C(C)C(=O)OCCOC(=O)c1ccccc1-c1c2ccc(=[N+](CC)CC)cc-2oc2cc(N(CC)CC)ccc12 ; [Cl-]]

(3) The compound of [Chemical Formula E] (11.0 g) obtained in 2-(2) was added to dichloromethane (100 g) and dissolved at room temperature. Lithium bis(trifluoromethane) sulfonamide (13.3 g) dissolved in water (200 g) was added dropwise to the solution of the compound of [Chemical Formula E] for 30 minutes. The mixture was stirred for about 1 hour and, upon completion of reaction, the organic layer was separated. After removing the solvent through distillation, methanol (50 g) was added and the mixture was stirred for 1 hour. The resulting mixture was added dropwise to water (200 g) for about 1 hour. The precipitated crystals were filtered, washed with water (200 g) and dried at 30° C. under reduced pressure to obtain a compound of [Chemical Formula F] (3.5 g).

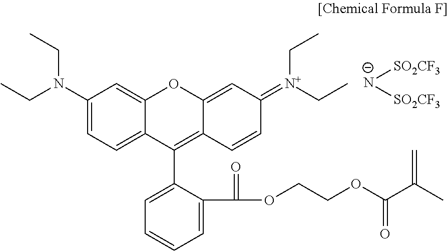

(4) Under nitrogen atmosphere, methyl ethyl ketone (26.5 g) was heated to 70° C. in a reactor. In a separate reactor, the compound of [Chemical Formula F] (6.4 g), methyl ethyl ketone (97.8 g) and 2,2′-azobisisobutyronitrile (0.3 g) were added and dissolved at 25° C. The resulting mixture was added to the previously prepared methyl ethyl ketone solution for 3 hours at 70° C. After the addition was completed, the mixture was maintained at 70° C. for 12 hours. Upon completion of reaction, after concentrating the methyl ethyl ketone to 3/2, crystallization was conducted by adding hexane (150 g). The resulting crystals were filtered and dried to obtain a compound of [Chemical Formula 4] (5.4 g).

Number-average molecular weight (Mₙ)=4184, weight-average molecular weight=5386, polydisparsity (PD)=3.02.

Synthesis Example 3, Synthesis of compound of [Chemical Formula 5]

(1) The compound of [Chemical Formula B] (10 g) synthesized in Synthesis Example 1 was added to dichloromethane (100 g) and dissolved at 26° C. After adding sodium trifluoromethanesulfonate (6.8 g) dissolved in water (200 g) added dropwise to the solution of the compound of [Chemical Formula B] for 30 minutes, the mixture was stirred for about 1 hour. Upon completion of reaction, the organic layer was separated. After removing the solvent through distillation, methanol (50 g) was added and the mixture was stirred for 1 hour. The mixture was added dropwise to water (200 g) for about 1 hour. The precipitated crystals were washed with wafer (200 g) and dried at 30° C. under reduced pressure to obtain a compound of [Chemical Formula G] (7.5 g).

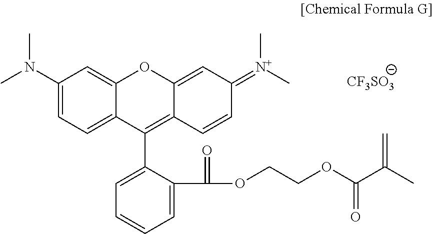

(2) Under nitrogen atmosphere, methyl ethyl ketone (19.1 g) was heated to 70° C. in a reactor. In a separate reactor, the compound of [Chemical Formula G] (135.0 g), methyl ethyl ketone (76.3 g) and 2,2′-azobisisobutyronitrile (0.3 g) were added and dissolved at 25° C. The resulting mixture was added to the previously prepared methyl ethyl ketone solution for 3 hours at 70° C. After the addition was completed, the mixture was maintained at 70° C. for 12 hours. Upon completion of reaction, after concentrating the methyl ethyl ketone to 3/2, crystallization was conducted by adding hexane (100 g). The resulting crystals were filtered and dried to obtain a compound of [Chemical Formula 5] (4.1 g).

Number-average molecular weight (Mₙ)=4832, weight-average molecular weight=5703, polydispersity (PD)=3.10.

Synthesis Example 4. Synthesis of compound of [Chemical Formula 8]

(1) The compound of [Chemical Formula E] (11 g) synthesized in Synthesis Example 2 was added to dichloromethane (100 g) and dissolved at room temperature. After adding sodium trifluoromethanesulfonate (6.8 g) dissolved in water (200 g) added dropwise to the solution of the compound of [Chemical formula E] for 30 minutes, the mixture was stirred for about 1 hour, Upon completion of reaction, the organic layer was separated. After removing the solvent through distillation, methanol (50 g) was added and the mixture was stirred for 1 hour. The mixture was added dropwise to water (200 g) for about 1 hour. The precipitated crystals were filtered, washed with water (200 g) and dried at 30° C. under reduced pressure to obtain a compound of [Chemical Formula H] (8.0 g).

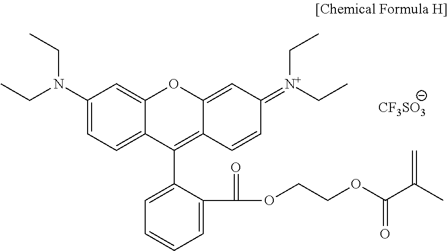

(2) Under nitrogen atmosphere, methyl ethyl ketone (20.8 g) was heated to 70° C. in a reactor. In a separate reactor, the compound of [Chemical Formula H] (5.4 g), methyl ethyl ketone (83.0 g) and 2,2′-azobisisobutyronitrile (0.3 g) were added and dissolved at 25° C. The resulting mixture was added to the previously prepared methyl ethyl ketone solution for 3 hours at 70° C. After the addition was completed, the mixture was maintained at 70° C. for 12 hours. Upon completion of reaction, after concentrating the methyl ethyl ketone to 3/2, crystallization was conducted by adding hexane (100 g). The resulting crystals were filtered and dried to obtain a compound of [Chemical Formula 6] (4.6 g).

Number-average molecular weight (Mₙ)=4713, weight-average molecular weight=5376, polydispersity (PD)=3.05.

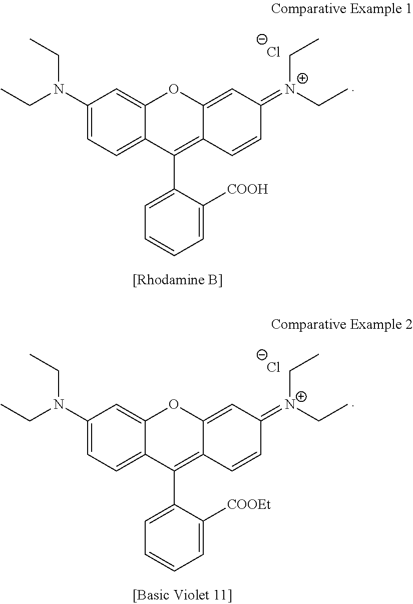

Comparative Example 3. [Japanese Patent Publication No. 8-230210, Japanese Patent Publication No. 7-242651]

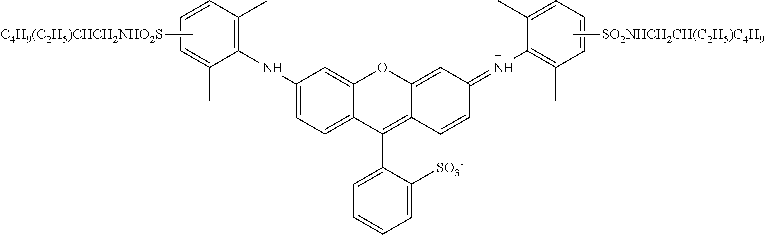

Test Example 1. Solubility

The dye compounds of Synthesis Examples 1-4 and Comparative Examples 1-3 were dissolved respectively in propylene glycol monomethyl ether acetate, propylene glycol monomethyl ether and cyclohexanone and solubility was measured. The result is shown in [Table 1].

TABLE 1

| | Syn. | Syn. | Syn. | Syn. | Comp. | Comp. | Comp. |
|---|---|---|---|---|---|---|---|
| Solvent | Ex. 1 | Ex. 2 | Ex. 3 | Ex. 4 | Ex. 1 | Ex. 2 | Ex. 3 |
| PGMEA | >10% | >10% | 0.6% | 0.8% | <0.1% | <0.1% | 0.4% |
| PGME | >10% | >10% | 6.5% | 7.2% | 1.2% | 1.4% | 4.5% |
| Cyclo- | >10% | >10% | >10% | >10% | 0.4% | 0.5% | 6.3% |
| hexanone | | | | | | | |

PGMEA: propylene glycol monomethyl ether acetate
PGME: propylene glycol monomethyl ether

As can be seen from [Table 1], the dye compounds of Synthesis Examples 1-4 according to the present disclosure exhibit high solubility in various solvents. In particular, the compounds of Synthesis Examples 1 and 2 exhibit very high solubility in all the solvents.

Test Example 2. Heat Resistance

A composition for testing heat resistance was prepared using the dye compound of Synthesis Examples 1-4 or Comparative Examples 1-2 (1g), PGME (15 g); N, N-dimethylformamide (3 g) and an acryl-based binder resin (17 g).

The photosensitive resin composition was coated on a 1-mm thick glass substrate to a thickness of 2 μm and dried on a hot plate of 80° C. for 90 seconds to form a coating film. After keeping the glass substrate in a hot-air dryer of 230° C. for 30 minutes, 1 hour and 2 hours, the change in absorbance at the maximum absorption wavelength was measured using the UV/vis spectrophotometer Agilent 8453 (Agilent). The result is shown in [Table 2].

TABLE 2

| | | Syn. | Syn. | Syn. | Syn. | Comp. | Comp. | Comp. |
|---|---|---|---|---|---|---|---|---|
| Temp. | | Ex. 1 | Ex. 2 | Ex. 3 | Ex. 4 | Ex. 1 | Ex. 2 | Ex. 3 |
| 80° C. | Initial | 0.7023 | 0.6322 | 0.6394 | 0.7610 | 0.7821 | 0.7314 | 0.6058 |
| 230° C. | 30 min | 0.6789 | 0.6178 | 0.6049 | 0.5747 | 0.6212 | 0.6012 | 0.5498 |
| | Change | 96.7% | 97.7% | 94.6% | 94.4% | 79.4% | 82.2% | 90.8% |
| | 60 min | 0.6571 | 0.5947 | 0.5829 | 0.5642 | 0.4712 | 0.4481 | 0.5198 |
| | Change | 93.6% | 94.1% | 91.2% | 92.7% | 60.2% | 61.3% | 85.8% |
| | 120 min | 0.6210 | 0.5690 | 0.5392 | 0.5186 | 0.3461 | 0.3661 | 0.4598 |
| | Change | 88.4% | 90.0% | 84.3% | 85.2% | 44.3% | 50.1% | 75.9% |

As seen from [Table 2], the coating films formed using the dye compound of Synthesis Examples 1-4 according to the present disclosure showed superior heat resistance and durability with less change in absorbance with time at high temperature.

Examples 1-4. Preparation of coloring resin composition for color filter

A photosensitive coloring resin composition was prepared with the following composition.

(a) Binder resin: benzyl methaorylate/methacrylic acid (60:40, w/w) copolymer (M_{w}20000) (13 g)

(b) Polyfunctional acryl monomer: dipentaerythritol pentaacrylate (7 g)

(c) Pigment dispersion: Pigment Blue 15:6 (1.0 g)

(d) Dye compound of Synthesis Examples 1-4 (0.7 g)

(e) Photopolymerization initiator: Irgacure OXE-01 (BASF) (2 g)

(f) Solvent: propylene glycol monomethyl ether acetate (5.3 g), cyclohexanone (62 g)

### Comparative Examples 1-3.

A coloring resin composition was prepared with the same composition as in Examples 1-4, except for using the compound of Comparative Examples 1-3 instead of the compound of Synthesis Examples 1-4.

Test Example 3, Color Characteristics

in order to test color characteristics, the coloring resin composition of Examples 1-4 and Comparative Examples 1-3 was spin coated on a glass substrate. After prebaking on a hot plate of 90° C. for 3 minutes, followed by cooling at room temperature for 1 minute, the glass substrate was exposed to light with 100 mJ/cm² (based on 365 nm). Subsequently, after postbaking in a convection oven of 230° C. for 30 minutes, color coordinates and brightness were measured using the spectrophotometer MCPD3000 (Otsuka Electronics). The result is shown in [Table 3].

TABLE 3

| | Color coordinate (x) | Color coordinate (y) | Brightness (Y) |
|---|---|---|---|
| Example 1 | 0.1350 | 0.113 | 13.59 |
| Example 2 | 0.1360 | 0.113 | 13.61 |
| Example 3 | 0.1359 | 0.113 | 13.57 |
| Example 4 | 0.1364 | 0.113 | 13.65 |
| Comparative | 0.1365 | 0.113 | 13.36 |
| Example 3 | | | |

Measurement could not foe made for Comparative Examples 1 and 2 because precipitation occurred due to low solubility. As seen from [Table 3], the coloring resin compositions of Examples 1-4 according to the present disclosure showed better color characteristics than the coloring resin composition of Comparative Example 3.

### INDUSTRIAL APPLICABILITY

A dye compound according to the present disclosure: or a polymer compound thereof has superior solvent resistance and superior miscibility with a pigment in an organic solvent. Further, it exhibits superior heat resistance, chemical resistance, light resistance and brightness due to the polymer structure. Accordingly, it can be industrially used to prepare a color filter exhibiting superior heat resistance, chemical resistance, light resistance and brightness.

1. A xanthene-based purple dye compound represented by [Chemical Formula 1] as a polymerizable monomer: 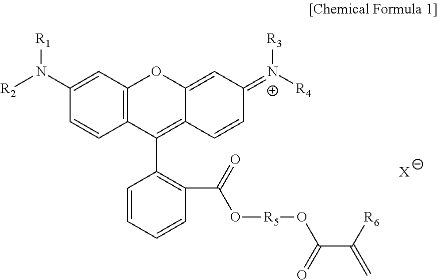
wherein
X⁻ is selected from a halogen anion, a perhalide anion, a fluorine complex anion, an alkyl sulfate anion, a sulfonate anion and a sulfonimide anion,
each of R₁, R₂, R₃ and R₄ is independently selected from hydrogen, a substituted or unsubstituted C₁-C₃₀ alkyl group, a substituted or unsubstituted C₂-C₄₈ alkenyl group and a substituted or unsubstituted C₆-C₁₀ aromatic hydrocarbon,
R₅ is a substituted or unsubstituted C₁-C₁₀ saturated hydrocarbon and
R₆ is hydrogen or a methyl group.

2. A purple dye polymer compound obtained from a xanthene-based compound represented by [Chemical Formula 2] as a monomer: 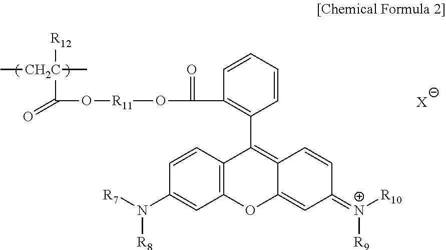
wherein
X⁻ is selected from a halogen anion, a perhalide anion, a fluorine complex anion, an alkyl sulfate anion, a sulfonate anion and a sulfonimide anion.
each of R₇, R₈, R₉ and R₁₀ is independently selected item hydrogen, a substituted or unsubstituted C₁-C₃₀ alkyl group, a substituted or unsubstituted C₂-C₄₈ alkenyl group and a substituted or unsubstituted C₆-C₁₀ aromatic hydrocarbon,
R₁₁ is a substituted or unsubstituted C₁-C₁₀ saturated hydrocarbon, and
R₁₂ is hydrogen or a methyl group.

3. The purple dye polymer compound according to claim 2, wherein the polymer compound has a weight-average molecular weight (M_{w}) of 2,000-150,000.

4. The xanthene-based purple dye compound according to claim 1, wherein, the compound represented by [Chemical Formula 1] is a compound represented by any of [Chemical Formula 3] through [Chemical Formula 6]:

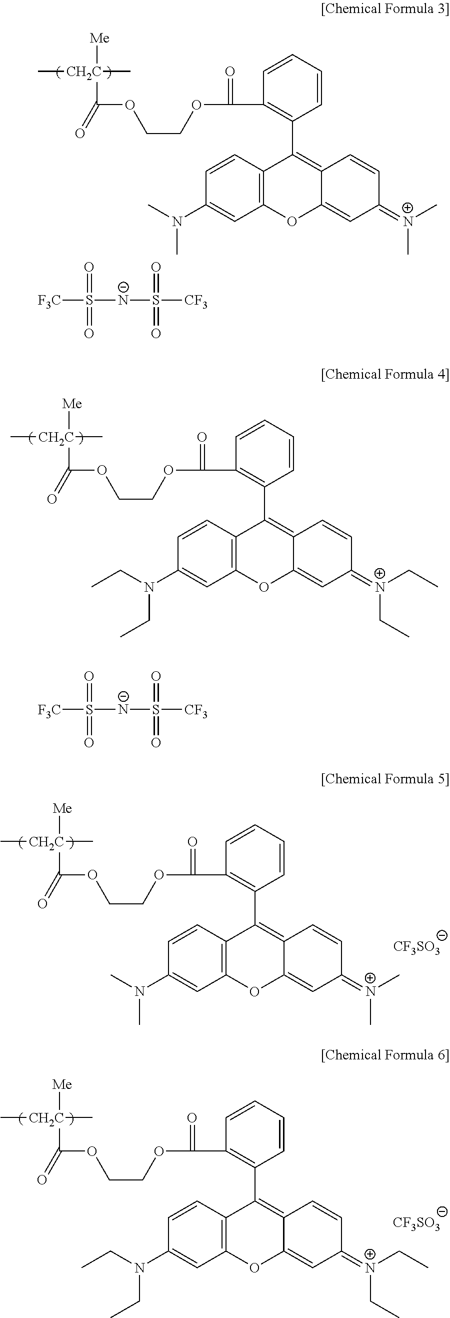

5. The purple dye polymer compound according to claim 2, wherein the compound represented by [Chemical Formula 2] is a compound represented by any of [Chemical Formula 3] through [Chemical Formula 6]:

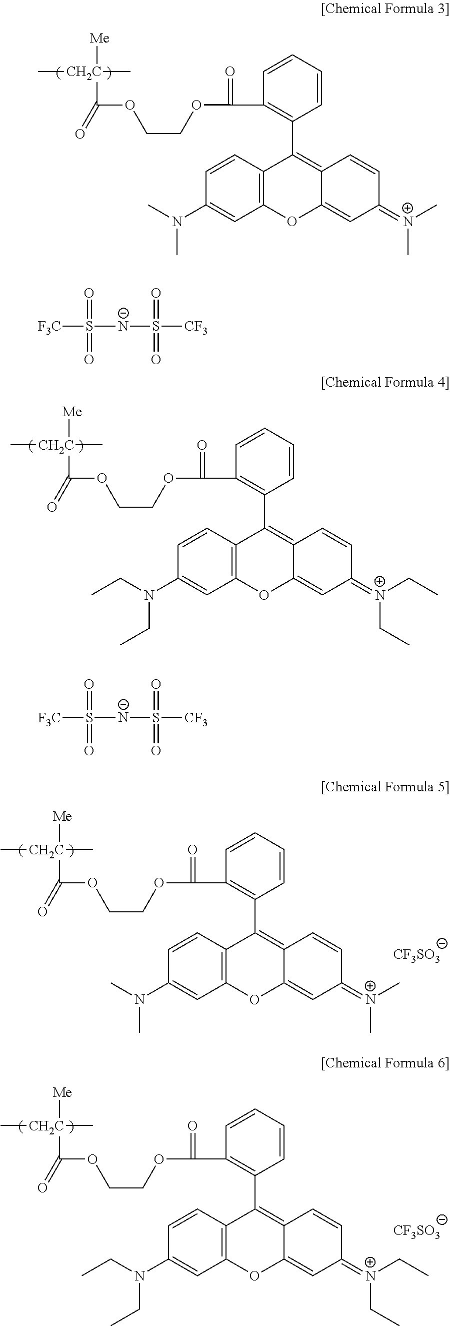

6. A coloring resin composition for a color filter, comprising: a purple dye compound; a blue pigment; a binder resin; a reactive unsaturated compound; a polymerization initiator; an organic solvent; and an additive,
wherein the purple dye compound is the purple dye compound represented by 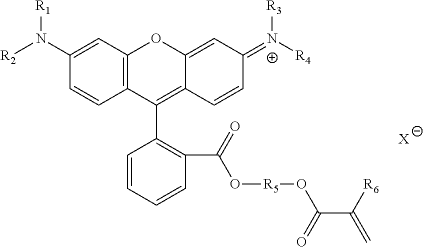
[Chemical Formula ] or the purple dye polymer compound obtained from the compound represented by 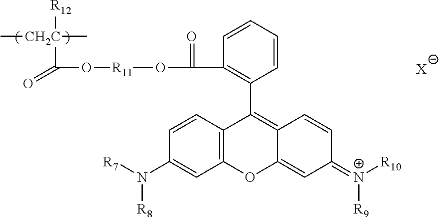
[Chemical Formula 2] as a monomer according to claim 2 wherein X⁻ is selected from a halogen anion, a perhalide anion, a fluorine complex anion, an alkyl sulfate anion, a sulfonate anion and a sulfonimide anion,
each of R₁, R₂, R₃, R₄, R₇, R₈, R₉ and R₁₀ are independently selected from hydrogen, a substituted or unsubstituted C₁-C₃₀ alkyl group, a substituted or unsubstituted C₂-C₄₈ alkenyl group and a substituted or unsubstituted C₆-C₁₀ aromatic hydrocarbon,
each of R₅ and R₁₁ is independently a substituted or unsubstituted C₁-C₁₀ saturated hydrocarbon and
each of R₆ and R₁₂ is independently a hydrogen or a methyl group.

7. The coloring resin composition for a color filter according to claim 6, wherein the purple dye compound is contained in an amount of 0.01-50 wt % based on the total weight of the coloring resin composition.

8. The coloring resin composition for a color filter according to claim 6, wherein the blue pigment is a copper phthalocyanine-based blue pigment.

9. The coloring resin composition for a color filter according to claim 6, wherein the weight ratio of the weight ratio of the blue pigment and the purple dye compound is from 99:1 to 50:50.

10. The coloring resin composition for a color filter according to claim 5, wherein the reactive unsaturated compound is selected from a group consisting of a thermosetting monomer or oligomer, a photocurable monomer or oligomer and a combination thereof.

11. The coloring resin composition for a color filter according to claim 6, wherein the polymerization initiator is selected from a group consisting of a thermal, polymerization initiator, a photopolymerization initiator and a combination thereof.

12. A color filter prepared using the coloring resin composition for a color filter according to claim 6.
